(19) United States
(12) Patent Application Publication
(10) Pub. No.: US 2003/0035169 A1
(43) Pub. Date: Feb. 20, 2003

(54) Interconnecting processing units of a stored program controlled system using wavelength division muliplexed free space optics

(76) Inventors: Charles Calvin Byers, Aurora, IL (US); Daniel Raymond Hatcher, Clinton, NJ (US)

Correspondence Address: Docket Administrator ( Room 3J-219), Lucent Technologies Inc., 101 Crawfords Corner Road, Holmdel, NJ, 07733-3030, US

(21) Appl. No.: 09/932,705

(22) Filed: Aug. 17, 2001

(51) Int. Cl. H04J 14/02; H04B 10/00

(52) U.S. Cl. 359/124; 359/172

(57) ABSTRACT

Internal communication signals in a stored program controlled system comprising a plurality of units configured to process signals are provided by an optical beam line which is proximal to all of the plurality of units. The system of this invention uses Wavelength Division Multiplexing techniques to provide a plurality of logically independent subchannels over a single shared free space optical beam line.

### CROSS-REFERENCE TO RELATED APPLICATIONS

This application is related to U.S. Patent Application Attorney Docket No. C. C. Byers 39-1, entitled “Interconnecting Processing units of a Stored Program Controlled System Using Free Space Optics”, filed concurrently herewith and commonly assigned to Lucent Technologies Inc., and incorporated by reference herein, with priority claimed for all commonly disclosed subject matter.

This application is also related to U.S. Patent Application Attorney Docket No. C. C. Byers 41-3, entitled “Interconnecting Processing Units Of A Stored Program Controlled System Using Time Division Multiplexed Free Space Optics”, filed concurrently herewith and commonly assigned to Lucent Technologies Inc., and incorporated by reference herein, with priority claimed for all commonly disclosed subject matter.

This application is also related to U.S. Patent Application Attorney Docket No. C. C. Byers 43-5, entitled “Interconnecting Processing Units Of A Stored Program Controlled System Using Space Division Multiplexed Free Space Optics”, filed concurrently herewith and commonly assigned to Lucent Technologies Inc., and incorporated by reference herein, with priority claimed for all commonly disclosed subject matter.

This application is also related to U.S. Patent Application Attorney Docket No. C. C. Byers 44-6, entitled “Installation Of Processing Units Into A Stored Program Controlled System Wherein The Component Processing Units Are Interconnected Via Free Space Optics”, filed concurrently herewith and commonly assigned to Lucent Technologies Inc., and incorporated by reference herein, with priority claimed for all commonly disclosed subject matter.

### FIELD OF THE INVENTION

This invention relates to the field of stored program controlled systems, including, but not limited to, telephone switching offices, data routers, and robotic machine tools; and, more specifically, this invention describes an optical communication path interconnect to provide communications for component processing units of the stored program controlled systems, wherein data is carried on the optical communication path using wavelength division multiplexing.

### BACKGROUND OF THE INVENTION

The invention of U.S. patent application Attorney Docket No. Byers 39-1 discloses a system and method for interconnecting processing units of a stored program controlled system using free space optics. According to this disclosure, an optical beam line carries signals among the various processing units. Multiple distinct streams of data are communicated within that system. When multiple distinct communication streams within a system or network share the same physical media, a multiplexing and Media Access Control (MAC) protocol is necessary for optimal system operation. These protocols help insure that the system performs at the desired capacity, performance and reliability levels.

One important function of any multiplexing and MAC protocol is to divide the limited capacity of the shared physical communication channel among the various logical streams or subchannels that share it. This subdivision of the shared physical channel provides capacity guarantees, so that each of the logical channels has an equal portion of the available capacity, or a pre-arranged larger or smaller proportion of this capacity. Pre-allocation of capacity provides a guaranteed level of capacity to all users. Such pre-allocation is often wasteful of system capacity because, if a given subchannel has no traffic to send, other sub-channels may have more traffic than they can handle.

Other multiplexing and MAC protocols provide statistical multiplexing of the system's capacity, where in all potential transmitters on the shared channel negotiate for an opportunity to transmit. The theoretical maximum load offered, if all transmitters are operating at full rate, often exceeded the capacity of the shared media, which requires various buffering, queuing and priority techniques to govern when each transmitter operates. This system has potential channel utilization efficiency advantages, at the expense of making it more difficult to guarantee a minimum individual subchannel capacity.

Another important function of any multiplexing and MAC protocol is to direct or route a given channel's traffic to the intended receiver over the shared medium. Channels in an optical system are often statically mapped using separate wavelengths (or similar separators as known in the art), and the receiver is determined by the wavelength assigned to the transmitter. In other cases, traffic is offered to the shared medium as packets. These packets contain a destination address, which is used by switching or routing functions to complete the connections.

The concept of priority is also important to multiplexing and MAC protocols. Some messages have a higher priority than others, based upon the importance or time sensitivity of their contents. The multiplexing and MAC protocol must take priority into account as it manages access to the shared medium.

Security is often an intrinsic function of multiplexing and MAC protocols. If there is a hazard associated with unauthorized listeners interception of a messages over the shared medium, the protocol can take steps to eliminate (or at least greatly reduce the impact of) this hazard. One means for heightened security is physically separating sensitive traffic from all other traffic in the various parallel sub-media in the transmission medium. A more common approach is to use some form of encryption at the transmitter, and decryption at only the authorized receiver(s).

A further function that multiplexing and MAC protocols provide is fault tolerance and fault recovery. If a failure occurs that disables the shared media or significantly reduces its capacity, the protocol invokes various diagnostic actions to discover the source of the problem and then appropriate recovery actions to attempt to correct the source of the problem. Often, the fault recovery operation involves switching the traffic to a redundant medium or attempting to shed load so only the highest priority traffic is allowed on the remaining capacity.

One form of multiplexing and MAC protocols usable in a free space optical beam line medium is wavelength division multiplexing. In a Wavelength Division Multiplexed (WDM) system, the shared medium is divided into a set of simultaneously-transmitted wavelengths. All subchannels sharing the medium are assigned specific wavelengths on which to carry traffic. The number of different wavelengths assigned may be equal for all subchannels, or some subchannels may be given higher capacity by assigning them a higher proportion of wavelengths available on the beam line on which to transmit.

Therefore, there is a need in the art to provide a free space optical interconnect between units of a stored program controlled system using a wavelength division multiplex system.

### SUMMARY OF THE INVENTION

This need is satisfied and a technical advance is achieved in the art by a system and method that provides wavelength division multiplexing in a system that uses free space optics to interconnect processing units of a stored program controlled system. The system of this invention uses Wavelength Division Multiplexing (WDM) techniques to provide a plurality of logically independent subchannels over a single shared free space optical beam line. The single logical beam is divided among the subchannels, with each subchannel operating on a selected wavelength or wavelengths.

In static WDM mapping, wavelengths are assigned to subchannels when the system is configured, and each processing unit using the beam line has a predetermined wavelength or wavelengths for communication with other processing units. The wavelength assignment may also be determined as the processing units are installed by selecting a laser of an individually designated wavelength at each transmit probe and a wavelength selective filter optical element at each receive probe. An alternate embodiment, dynamic mapping, uses frequency agile lasers and tunable filters at the receive probes to dynamically assign wavelengths to the various subchannels. Dynamic assignment has advantages in versatility, and reliability, but at the cost of more complex hardware.

### BRIEF DESCRIPTION OF THE DRAWINGS

A more complete understanding of this invention may be obtained from a consideration of the specification taken in conjunction with the drawings, in which:

FIG. 1 is a perspective view of a beam line illustrating the relationship of the beam line and probes according to a general overview of an exemplary embodiment of this invention;

FIG. 2 is a cross-sectional view of the beam line taken along line 2-2 of FIG. 1;

FIG. 3 is an exemplary embodiment of transmitting and receiving probes of FIGS. 1 and 2;

FIG. 4 is a block diagram of a hub of the beam line of FIGS. 1 and 2 according to an exemplary embodiment of this invention;

FIG. 5 is a representative wavelength spectrum of the beam line of FIG. 1 operating at full capacity; and

FIG. 6 is a flowchart of processing for bandwidth management tasks of increasing and decreasing the capacity of each subchannel.

### DETAILED DESCRIPTION

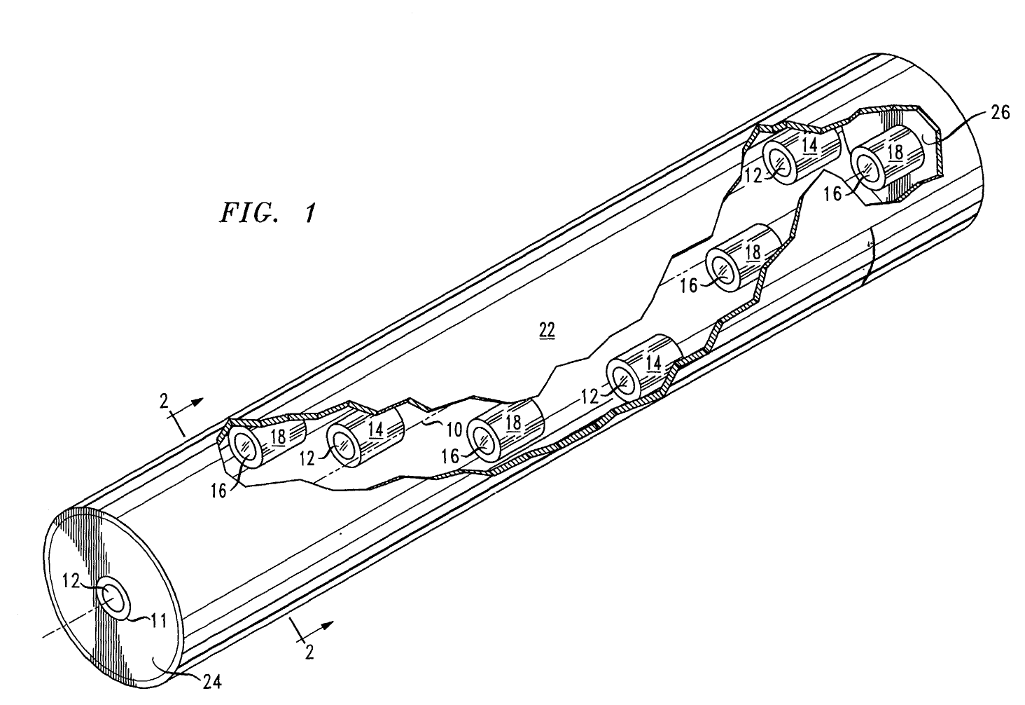

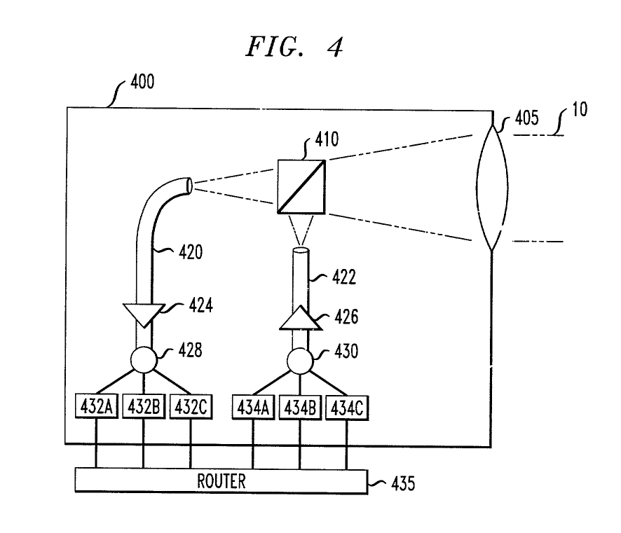

Turning to FIG. 1, a perspective view of a free space beam line 10 according to an exemplary embodiment of this invention is shown. According to this exemplary embodiment, a free space beam line 10 is generated at hub 11 which projects optically encoded signals, as will be described below in connection with FIG. 4

A plurality of transmitters 12 within transmitting probes 14 and receivers 16 within receiving probes 18 are distributed throughout beam line 10 along the outer periphery in the form of a spiral or helix, in this exemplary embodiment. Other possible configurations of probes along the beam line will be apparent to one skilled in the art after studying this disclosure. The probes are distributed in a helix in this exemplary embodiment so that there is a minimal amount of shadowing; that is, one probe being in the shadow of a previous probe in beam line 10, inhibiting the probe in the shadow from transmitting or to receiving signals in beam line 10.

Beam line 10 may be contained within a reserved volume or conduit 22 in an enclosure, such as a cylinder or pipe or, alternatively, may be in the open. If the beam line 10 is contained in a conduit, then the interior surface may be optically absorptive or optically reflective depending upon the length of the pipe, the wavelength of the signal generated by the laser within transmitter 12 and loss budget to provide optimal reception of optically encoded signal by the plurality of receiving probes 18 throughout the length of beam line 10.

Conduit 22 includes, in this exemplary embodiment, a first terminal unit 24 comprising a hub 11 and a second terminal unit 26. First terminal unit 24 originates free space beam line 10 and second terminal unit 26 terminates the portion of free space beam line 10 passing beyond the probes 18. As will be discussed further, below, first terminal unit 24 and/or second terminal unit 26 may include both transmitters and receivers, and may be also interconnected to recycle the encoded signal.

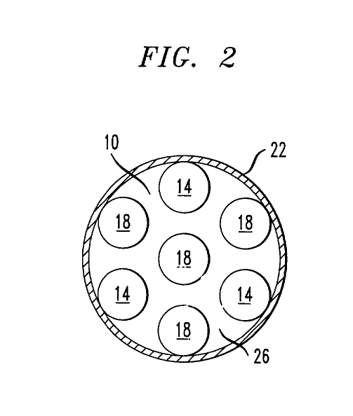

FIG. 2 illustrates a view looking down a cross-section of beam line 10 taken along line 2-2 of FIG. 1. Conduit 22 includes a plurality of transmitting probes 14 and receiving probes 18 around its inner edge. In the illustration of FIG. 2, the laser of hub 11 (FIG. 1) focuses beam line 10 to encompass the interior circumference of conduit 22 whereby each probe 18 receives the encoded optical signal. Second terminal unit 26 is illustrated herein as comprising a receiving probe 18. (Second terminal unit 26 may also include a transmitter 12, not shown.) Alternatively, second terminal unit 26 may comprise another hub or an end cap. An end cap may be absorptive in order to stop the beam line 10 or may be reflective (i.e., a mirror or retroreflector) to recycle beam line 10 in the opposite direction.

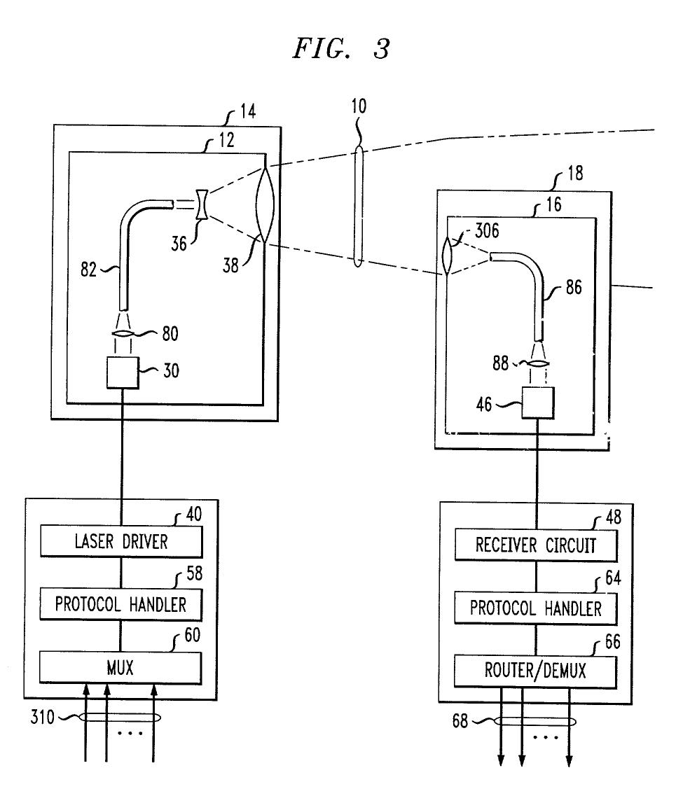

Turning now to FIG. 3, exemplary embodiments of a transmitting probe 14 and a receiving probe 18 configured for wavelength division multiplexing (WDM) of the bandwidth of a beam line are shown. Transmitting probe assembly 14 includes transmit electro-optical components 12, and the receiving probe assembly 18 includes receive electro-optical components 16. Light of a pre-specified, closely controlled wavelength is transmitted over free space beam line 10 from transmit probe 14 to receive probe 18 to effect communication between two processing units in the system.

Transmit electro-optical assembly 12 includes a laser 30 that operates at a controlled wavelength, a condensing lens 80, a fiber 82 to carry the light to the beam line and a diverging lens 36 and converging lens 38. Lenses 36 and 38 represent a reverse Galilean telescope that expands the small diverging beam from fiber 80 into a larger, less divergent beam, and directs it into free space beam line 10.

Laser driver 40 energizes laser 30. Laser driver 40 includes circuits to provide the correct bias current and modulation to laser 30, but also includes elements necessary to control and monitor the emission wavelength of laser 30, as known in the art. Feedback is maintained between laser 30 and laser driver 40 to establish servo loops needed to precisely control the emission power, emission wavelength, and temperature of laser 30. Protocol handler 58 provides a serial bitstream used by laser driver 40 to modulate laser 30. Mux 60 merges data from all the various sources of bearer, control and administrative information arriving on links 310, which are to be transmitted to other processing units.

Receive electro-optical assembly 16 includes a converging lens 306 to focus light from beam line 10 onto fiber 86. Fiber 86 carries the light from the beam line to wavelength selective photodetector 46. Lens 88 focus the light from fiber 86 to photodetector 46.

Wavelength selective photodetector 46 includes a tunable optical bandpass filter, as known in the art, to select a single wavelength from the plurality of wavelengths present in beam line 10 (and on fiber 86). This filtering function must be very selective, as the wavelength spacing may be very close. The photoreceiver element, (i.e., a photodiode in the preferred embodiment) contained in 46 must be illuminated by only a single wavelength to reliably receive information from a single subchannel.

Receiver circuit 48 includes all the circuits typical of known photoreceivers, including a transimpediance amplifier, clock recovery logic, and a decision circuit. In addition, receiver 48 includes elements needed to tune the wavelength selective filter contained in 46. Protocol handler 64 receives the serial stream and clock recovered in receiver circuit 48, and reassembles it into a data stream. This data stream (bearer, control and administrating data) is then sent to router/demux 66, which routes it to one of a plurality of possible destinations over links 68.

FIG. 4 is a block diagram of hub 11, which may be first terminal unit 24 and/or second terminal unit 26 (FIG. 1). Hub 11 must simultaneously terminate all wavelengths on the free space beam line in each direction. Beam line 40 enters hub electro-optical assembly 400 through focusing lens 405. Light from beam line 40 passes through dichoric beam splitter 410, which divides the optical energy passing through into two bands: a band of longer wavelengths that pass straight through the beam splitter 410, and a shorter band of wavelengths that turn 90 degrees. Channels from the processing units are in the longer wavelength band, so they pass straight through the beam splitter 410, and are directed onto fiber 420. Wavelengths being sent to the processing units are in the shorter band, and therefore emerge from fiber 422, turned 90 degrees by beam splitter 410, and are transmitted through lens 405 and onto beam line 40.

Erbium Doped Fiber Amplifier 424 boosts the amplitude of the receive optical signal, which passes through wavelength selective fiber splitter 428 and onto photoreceivers 432A-432C, which contain photodiodes, transimpediance amplifiers, clock recovery circuits, and decision circuits, as known in the art. One photoreceiver is required per wavelength received at hub 11. Electrical signals from the photoreceivers then pass to router 435. Router 435 receives one electrical stream per wavelength from photoreceivers 432A-432C, decodes their addresses, and routes them as electrical signals to the appropriate transmitter assembly 434A-434C.

Transmitter assemblies 434A-434C include laser drivers, laser diodes, and feedback circuits to stabilize the laser's power and wavelength, as known in the art. Each of the optical transmitter assemblies 434A-434C operates on a specific wavelength, with one transmitter required per wavelength transmitted into the beam line 40. Optical signals from transmitter assemblies 434A-434C are combined in coupler 430, boosted by Erbium Doped Fiber Amplifier 426, and sent through beamsplitter 410 and lens 405 onto beam line 40.

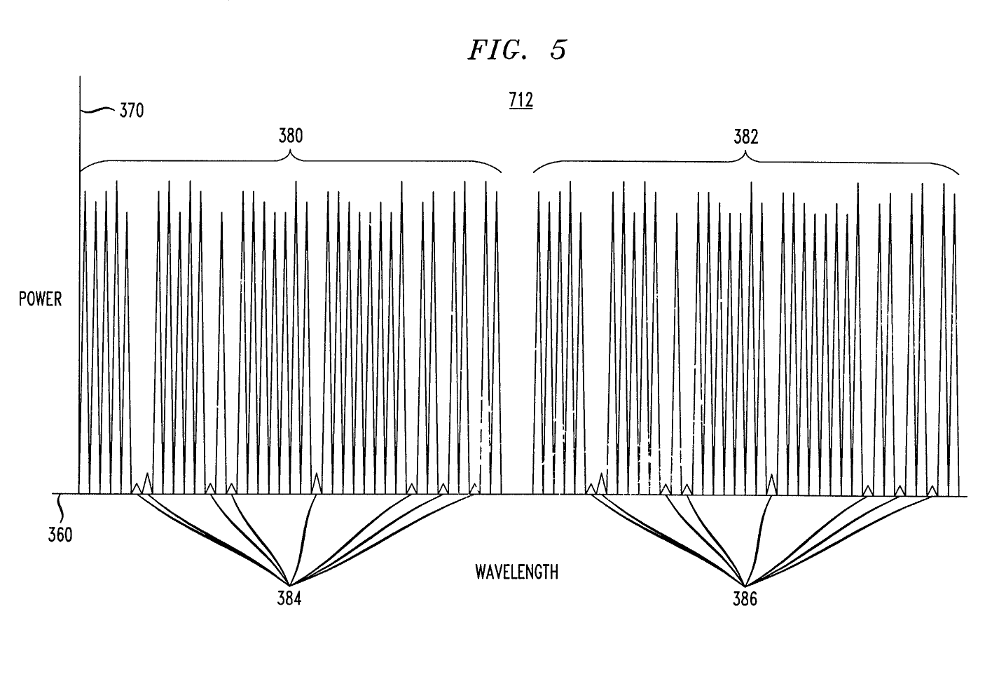

FIG. 5 represents a wavelength spectral plot of a WDM system according to an exemplary embodiment of this invention in operation. Eighty distinct wavelengths are used to interconnect 32 processing units in this exemplary embodiment. Each processing unit is assigned a single wavelength for transmission toward central hub 11, and a second wavelength over which hub 11 transmits messages back to the processing unit. Wavelengths used for transmission towards hub 11 are grouped in the longer wavelength spectrum, and wavelengths used to transmit from hub 11 back to the processing units occupy a group in the shorter wavelength spectrum.

This plot represents output from a spectrophotometer monitoring the entire light spectrum in free space beam line 10. The horizontal axis 360 represents the wavelength of the monitored light, and the vertical axis 370 represents the power monitored on each wavelength. The group of 32 longer wavelength peaks 380 is the set of subchannel signals from the processing units toward the hub 11. The group of shorter wavelength peaks 382 is the optical signal set from the hub to the individual processing units. Unused wavelengths 384 and 386 are spare; to be used for system expansion or in case a failure requires reconfiguration of the wavelength assignments. Unused wavelengths 384 and 386 could also be used to balance the load of the system. Each processing unit transmits and receives its primary traffic on its assigned wavelengths 382 and 384, but if the traffic load exceeded the capacity of these channels, spare wavelengths 384 and 386 can be allocated to supplement the channels that are in overflow. Using this overload control scheme necessitates each of the processing unit probes being able to transmit and receive on two or more wavelengths, its primarily assigned wavelength, and one or more supplemental wavelengths. The supplemental wavelengths can be a shared, managed free resource pool. Of course, as spare wavelengths 384 and 386 are activated, the amplitude of their peaks on FIG. 5 would increase.

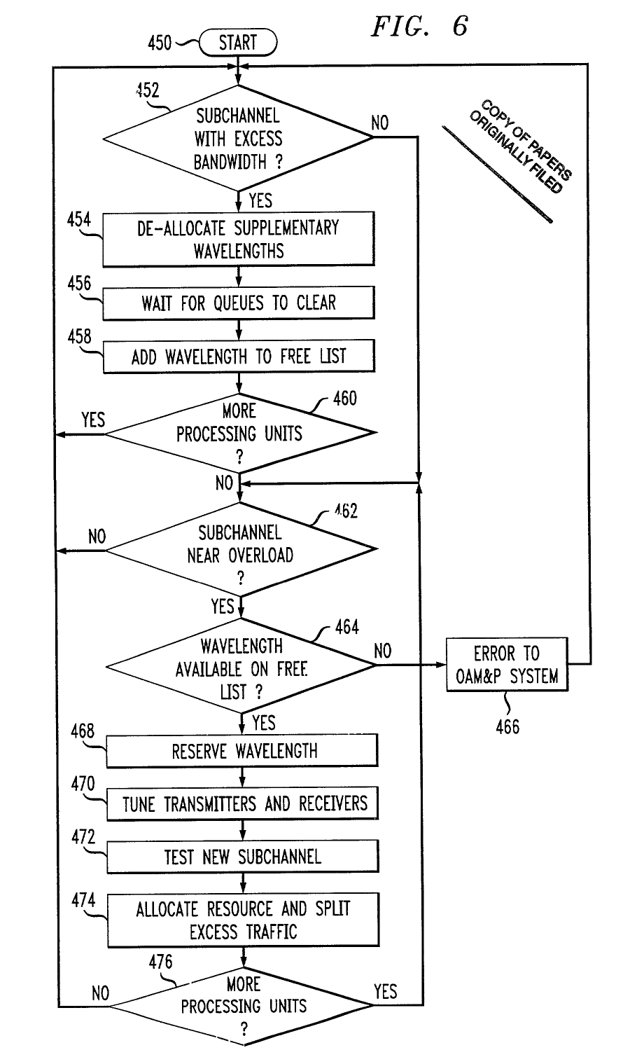

FIG. 6 is a flowchart for managing the dynamically allocated bandwidth available if more than one wavelength agile laser and photoreceiver is used at each processing unit. Dynamic bandwidth allocation operation starts at 450. In decision diamond 452, a determination is made if any of the processing units have excessive bandwidth allocations. This determination is made by polling all processing units with more than one wavelength assigned in each direction, and calculating whether the total load has fallen below 90% of the capacity of a single channel. If so, the supplementary wavelength channel is de-allocated from the processing unit in action box 454. Any traffic that may be queued for transmission is allowed to clear in action box 456. Processing proceeds to action box 458, where the newly freed wavelength is added to the free list. In decision diamond 460, a determination is made if there are any remaining processing units to check for excess bandwidth.

The determination of decision diamond 462 comprises determining if any subchannel is approaching overload. Each processing unit is polled to determine if its transmit queue is over 90% full. If so, decision diamond 564 determines if a supplementary wavelength is available to take the added traffic. If not, a system overload error is sent to the Operations Administration, Maintenance and Provisioning system in action box 466. If a supplementary wavelength is available, a wavelength is reserved in action box 468. The lasers and photoreceivers associated with both transmitters and both receivers are programmed to tune their wavelengths in action box 470. Tests are performed in action box 472 to determine if the new channels are performing correctly. In action box 474, the wavelength is allocated, and traffic begins to flow to relieve the overloaded primary wavelength. Decision diamond 478 tests to see if other processing units are in overload. The entire bandwidth management loop repeats infinitely as long as the system operates.

It is to be understood that the above-described embodiments are merely illustrative principles of the invention and that many variations may be devised by those skilled in the art without departing from the scope of this invention. It is, therefore, intended that such variations be included within the scope of the following claims.

What is claimed is:

1. A method for use in a stored program controlled system comprising a plurality of processing units and a signal generator for interconnecting processing units using wavelength division multiplexing over a free space beam line, said method including the steps of:
generating a message at one of said plurality of processing units for a destination processing unit comprising another one of said plurality of processing units;
modulating the message on a specific optical wavelength;
transmitting the modulated message over said free space beam line;
receiving said modulated message at a wavelength selective receiver;
selecting a particular wavelength at said receiver; and
recreating the message and forwarding it to said destination processing unit.

2. A method in accordance with claim 1 wherein said signal generator includes a tunable laser, said step of modulating comprising:
tuning said tunable laser to said specific optical wavelength prior to modulating the message on said specific optical wavelength.

3. A method in accordance with claim 1 wherein said signal generator includes a plurality of fixed wavelength lasers, each of which operates on a different wavelength, said step of modulating comprising:
delivering said message to one of said plurality of fixed wavelength lasers corresponding to said specific optical wavelength prior to modulating the message on said specific optical wavelength.

4. A method in accordance with claim 1 wherein said wavelength selective receiver comprises tunable photodetectors, said step of selecting comprising:
tuning said tunable photodetector to said specific optical wavelength.

5. A method in accordance with claim 1 wherein said wavelength selective receiver comprises one of a plurality of fixed wavelength photodetectors, all operating at different wavelengths, said step of selecting comprising:
receiving only the fixed wavelength.

6. A method in accordance with claim 1 wherein said wavelength selective receiver comprises one of a plurality of fixed wavelength photodetectors and a tunable photodetector, said method further including the step of:
dynamically allocating bandwidth by receiving messages on a primary wavelength at said one of a plurality of fixed wavelength photodetectors and receiving one or more messages on other wavelengths at said tunable photodetector.

7. A method in accordance with claim 1 wherein each of said processing units includes a fixed transmitter comprising a laser configured to modulate on a fixed optical wavelength over said free space optical beam line and a tunable transmitter comprising a tunable laser configured to modulate on multiple, selectable wavelengths, said method further including the step of:
dynamically allocating bandwidth by transmitting messages on a primary wavelength at said fixed wavelength transmitter and transmitting one or more messages on other wavelengths at said tunable transmitter.

8. A system for use in a stored program controlled system comprising a plurality of processing units for interconnecting said processing units using wavelength division multiplexing over a free space optical beam line, said system comprising:
a transmitter configured to generate a message at one of said plurality of processing units for a destination processing unit comprising another one of said plurality of processing units;
a laser configured to modulate the message on a specific optical wavelength over said free space optical beam line;
a wavelength selective receiver; and
means at said receiver for recreating the message and forwarding it to said destination processing unit.

9. A system in accordance with claim 8 wherein said laser comprises a tunable laser configured to modulate at a specific optical wavelength before transmitting said message.

10. A system in accordance with claim 8 wherein said laser comprises a fixed wavelength laser.

11. A system in accordance with claim 8 wherein said wavelength selective receiver comprises a tunable photodetector.

12. A system in accordance with claim 8 wherein said wavelength selective receiver comprises a fixed wavelength photodetector.

13. A system in accordance with claim 8 wherein said wavelength selective receiver comprises a fixed wavelength photodetector and a tunable photodetector configured to dynamically allocating bandwidth by receiving messages on a primary wavelength at said one of a plurality of fixed wavelength photodetectors and receiving one or more messages on other wavelengths at said tunable photodetector.

14. A system in accordance with claim 8 further including means for dynamic wavelength allocation and deallocation responsive to system load.
